(19) United States
(12) Patent Application Publication
(10) Pub. No.: US 2008/0195251 A1
(43) Pub. Date: Aug. 14, 2008

(54) Beverage Control System

(76) Inventor: Andrew Milner, Nedlands (AU)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 11/660,874

(22) PCT Filed: Aug. 24, 2005
(86) PCT No.: PCT/AU05/01272

§ 371 Date: Aug. 24, 2007

(30) Foreign Application Priority Data
Aug. 25, 2004 (AU) 2004904823

(51) Int. Cl. G06F 17/00; B65D 55/02; B65D 25/52; B67D 3/00; B67D 5/08

(52) U.S. Cl. 700/237; 222/1

(57) ABSTRACT

Pourer (14) including a beverage dispensing controller (23) including a pinch valve solenoid (40, 83) to control the dispensing of a beverage; a cap (21) includes a locking system to releasably secure the cap to a beverage container (12). The cap has a cap body (31) having an outer duct (43), and the locking system includes a collar (32) with a central aperture for receiving and allowing the collar (32) to pass over the outer duct, and a locking tab located on the cap body. A clamp (34) is engaged by a slide (33) to thereby secure the cap to the container (12) and a locking pin (38) which when engaged acts to prevent rotation of the collar (32). Also, disclosed is a system (FIG. 2) that includes the pourer (14) having a unique identification (ID) and can trasmit wireless signals to a base station (15) about the amount of beverage dispensed; a personal identification unit (17) such as a passive RFID tag to identify the barman pouring the beverage; and an infra-red sensor (7) to allow the pourer (14) to communicate with a container scanner (18) that reads the barcode on the container.

### FIELD OF THE INVENTION

The present invention is directed to a beverage control system suitable for controlling and monitoring the dispensing of beverages. It is particularly suited for the dispensing of alcoholic beverages at bars. BACKGROUND ART

Research indicates that bars lose anywhere between 15% and 35% of their alcoholic beverages to theft and over-pouring. This loss has a major effect on the profitability of bars. Many marginal or loss-making bars would be profitable if they had effective stock control.

The problem is due to the nature of the business. Bars are busy, payments are usually in cash, and because the customer experience is paramount, bar operators are loathe to employ stock control techniques that interfere with the ambience, or atmosphere of a bar. Point of sale (POS) systems have come a long way in recent years, and many now comprise sophisticated revenue tracking and reporting. However, POS systems don't solve the real problem—they can only report what bar staff ring up, not what actually happens behind the bar.

There are a number of alcohol dispensing and control systems on the market that attempt to solve this problem. Typically they fall into one of the following categories:
Systems that deliver liquor over remote lines. The bottles are usually ‘behind the scenes’, and liquor is dispensed through a post-mix or fixed type tap. While secure, these systems are not suited to most bar environments as they destroy the traditional intimacy and atmosphere of a bartender pouring from the bottle right in front of the customer.
Wireless bottle tops. These are units that fix to the top of a bottle and report the amount of liquor poured via a wireless link. Some of these systems are relatively unobtrusive (some are not!) however they all suffer from two basic problems—they don't actually secure the liquor, since anyone can remove them, and they don't identify the individual doing the pouring.
Ring activated spouts. These systems work by affixing a spout to the bottle using heatshrink-tubing. When the bartender wants to pour from the bottle, an actuator ring is placed over the spout which unlocks the pouring mechanism. The big problem with this type of system is that the actuator ring is a large bulky device attached to a control box via a heavy coiled wire.
Finally, there are stock-taking systems. These systems are not designed to control the dispensing process per se, rather they are used for accurate counting inventory on a periodic basis. These systems employ a variety of technologies, including barcode scanners and weighing scales. Even if control over the dispensing process isn't important to you, the problem with these systems is that inventory levels can only be calculated when you do a manual stock take—usually weekly or monthly.

All of the above systems suffer from one or more major drawbacks that severely limit their usefulness to most bar operators. What is needed is a system that does not interfere with bartenders or the visual appeal of the bar, while ideally physically securing liquor against theft, and tracking liquor usage with a high level of granularity—down to the individual bartender level per hour, for comparison against POS revenue.

It is therefore an object of the present invention to provide an improved beverage control system and which ideally shows accurate usage against actual revenue in a non-intrusive and non-prescriptive way.

Preferably the system should also be able to protect against the possible pilfering of liquor.

### DISCLOSURE OF THE INVENTION

With the above object in mind, the present invention provides in one aspect a pourer including:

a beverage dispensing controller including a valve to control the dispensing of a beverage by the pourer;

a cap including a locking system to releasably secure the cap to a beverage container, wherein the cap further includes a cap body having an outer duct extending from the cap body;

wherein the locking system further includes:

a collar with a central aperture for receiving the outer duct, the aperture allowing the collar to pass over the outer duct and at least one locking tab located on the cap body;

a slide which engages the collar;

a clamp engaging at least one locking tab on the cap body, wherein the clamp is engaged by the slide to thereby secure the cap to the beverage container; and

a locking means which when engaged acts to prevent rotation of the collar.

In another aspect, the present invention provides a beverage control system including:

at least one beverage container;

at least one pourer releasably secured to a respective outlet of each beverage container,

wherein the pourer further includes:

a beverage dispensing controller including a valve to control the dispensing of a beverage by the pourer;

an actuator to control the valve, wherein the actuator is responsive to a control signal transmitted remotely from a base station when the base station is signalled that an authorised user is attempting to pour a beverage from the container, the control signal is transmitted by wireless transmission and received by a transceiver associated with the pourer.

In a further aspect, the present invention provides a method of operating a beverage control system including:

dispensing a beverage from a releasably secured pourer by a beverage dispensing controller including a valve to control the dispensing of the beverage from the pourer;

controlling the valve by an actuator, wherein the actuator is responsive to a control signal transmitted remotely from a base station when the base station is signalled that an authorised user is attempting to pour a beverage from a beverage container, the control signal being transmitted by wireless transmission and received by a transceiver associated with the pourer.

In still another aspect the present invention provides a pourer including:

a beverage dispensing controller including a valve to control the dispensing of a beverage by said pourer;

a cap including a locking system to releasably secure the cap to a beverage container, wherein the cap further includes a cap body having an outer duct extending from the cap body;

wherein the locking system further includes:

a collar with a central aperture for receiving the outer duct, the aperture allowing the collar to pass over the outer duct and at least one protrusion located on the outer duct;

a slide which engages the collar;

a clamp engaging the at least one protrusion on the outer duct, wherein the clamp is engaged by the slide to thereby secure the cap to the beverage container; and

a locking means which when engaged acts to prevent rotation of the collar.

According to a preferred embodiment, the beverage dispensing controller is adapted to control the time for which the beverage is dispensed. Alternatively the beverage dispensing controller is adapted to control the volume of beverage which is dispensed.

According to a preferred feature of the invention, the system is adapted to calculate the volume of beverage dispensed.

According to a preferred feature of the invention, a transceiver is associated with the pourer.

According to a preferred feature of the invention, the beverage control system further includes a personnel identification means adapted to identify that the user is authorised.

According to a preferred embodiment, the personnel identification means includes an RFID tag.

According to a preferred embodiment, the personnel identification means is located in a wristband adapted to be applied to the wrist of a user.

According to a preferred embodiment, the personnel identification means is located in a ring adapted to be located on a finger of a user.

According to a preferred feature of the invention the pourer further includes an identification scanner adapted to detect the proximity of the personnel identification means.

According to a preferred feature of the invention the beverage control system further includes a container identification means adapted to provide the identity of the container to the system.

According to a preferred embodiment, the container identification means includes a cordless barcode scanner adapted to scan a standard barcode disposed on the container.

According to a further aspect, the invention resides in a container identification means adapted to cooperate with the pourer, the container identification means being housed in a housing having a first and a second pourer engagement means, the pourer engagement means being alternately adapted to cooperate with the pourer, whereby when the first pourer engagement means is engaged with the pourer an unlock signal is signalled to the pourer and when the second pourer engagement means is engaged with the pourer a lock signal is signalled to the pourer.

According to a preferred feature of the invention, a lock signal must be completed by identification of the container by the container identification means.

According to preferred feature of the invention, the pourer further includes a rechargeable battery adapted to be recharged by inductive charging.

According to a preferred embodiment, the inductive charger is associated with the storage facility for the container.

According to a preferred feature of the invention, the beverage dispensing controller includes a first tilt switch adapted to identify when the container is in an inverted orientation.

According to a preferred feature of the invention, the beverage dispensing controller includes a second tilt switch adapted to identify when the container is in an upright orientation.

According to a preferred feature of the invention, beverage control system includes a server including a computer system adapted to configure the system.

According to a preferred feature of the system, the server further includes a database adapted to store information concerning the operation of the system and record information output by the system.

According to a preferred feature of the invention, the beverage control system includes at least one base station adapted to receive information from at least one pourer and to transmit signals to the pourer or pourers.

According to a preferred feature of the invention, the base station reports information to the server and receives configuration information from the server.

According to a further aspect, the invention resides in a method of operating a beverage retailer, the method including the use of a beverage control system as previously described.

According to a further aspect, the invention resides in a lockable pourer for a container, the pourer including locking means adapted to lock the pourer into engagement with the outlet of a beverage container.

According to a preferred feature of the invention, the locking means is unlocked only after identification of an authorised user.

According to a preferred feature of the invention, the identity of the authorised user is verified locally.

According to a preferred feature of the invention, the identity of the authorised user is verified remotely.

According to a further aspect, the invention resides in a locking system adapted to lock a re-usable cap to the mouth of a container, the locking system adapted to be used in association with a cap body adapted to cover the mouth, a collar retained relative to the body and rotatable about the body, the collar engaging a slide adapted to slide within the collar between a retracted position and an extended position and a clamp adapted to be engaged by the slide when the slide is in the extended position to cause, in use, engagement of the clamp with the container to thereby secure the cap to the container, wherein the locking system further includes a locking means which when engaged acts to prevent rotation of the collar in a direction which would result in the slide moving towards the retracted position but permits such rotation when disengaged.

According to a preferred feature of the invention the locking system permits rotation in an opposite direction when engaged.

According to a preferred feature of the locking mechanism can be disengaged by an electric signal.

According to a preferred embodiment, the locking mechanism can be disengaged remotely.

According to a preferred embodiment, the clamp includes a plurality of fingers about its periphery extending generally parallel to a central axis from a rim, the fingers having radially inwardly directed teeth at the ends disposed from the rim and being adapted to be deflected inwardly to drive the teeth into engagement with the container by deflection of the fingers due to engagement with the slide when in and extended position.

The invention will be more full understood in light of the following description of several specific embodiments.

### BRIEF DESCRIPTION OF THE DRAWINGS

The description is made with reference to the accompanying drawings of which:

FIG. 1 shows a block diagram of a beverage control system according to a first embodiment of the present invention;

FIG. 2 shows a schematic diagram of a beverage control system according to the first embodiment of the present invention;

FIG. 3 shows a first isometric exploded view of a lockable cap according to the first embodiment of the present invention;

FIG. 4 shows an isometic exploded view of a lockable cap according to a further arrangement of the first embodiment of the present invention;

FIG. 5 shows a second isometric exploded view of the bottom half of the components of the lockable cap of FIG. 4;

FIG. 6 shows an isometric exploded view of the top half of the components of the lockable cap of FIG. 4;

FIG. 7 shows a section view of a lockable cap according to the first embodiment;

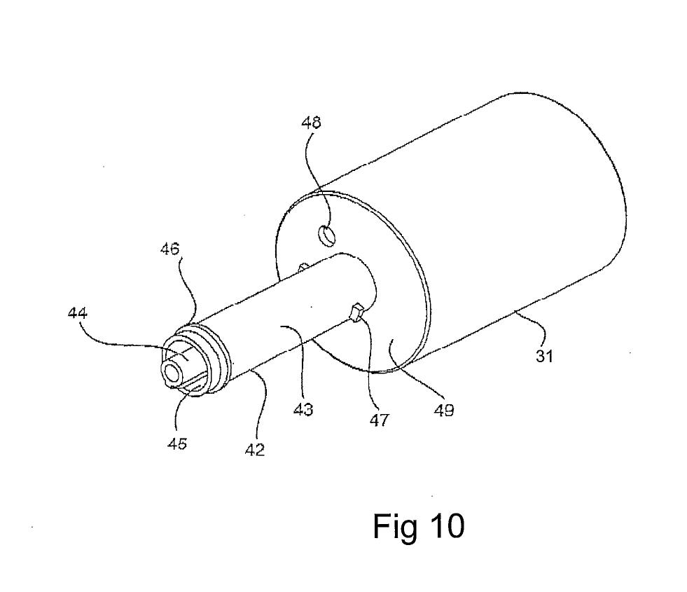

FIG. 8 shows an assembled view of a lockable cap according to a further arrangement of the first embodiment of the present invention;

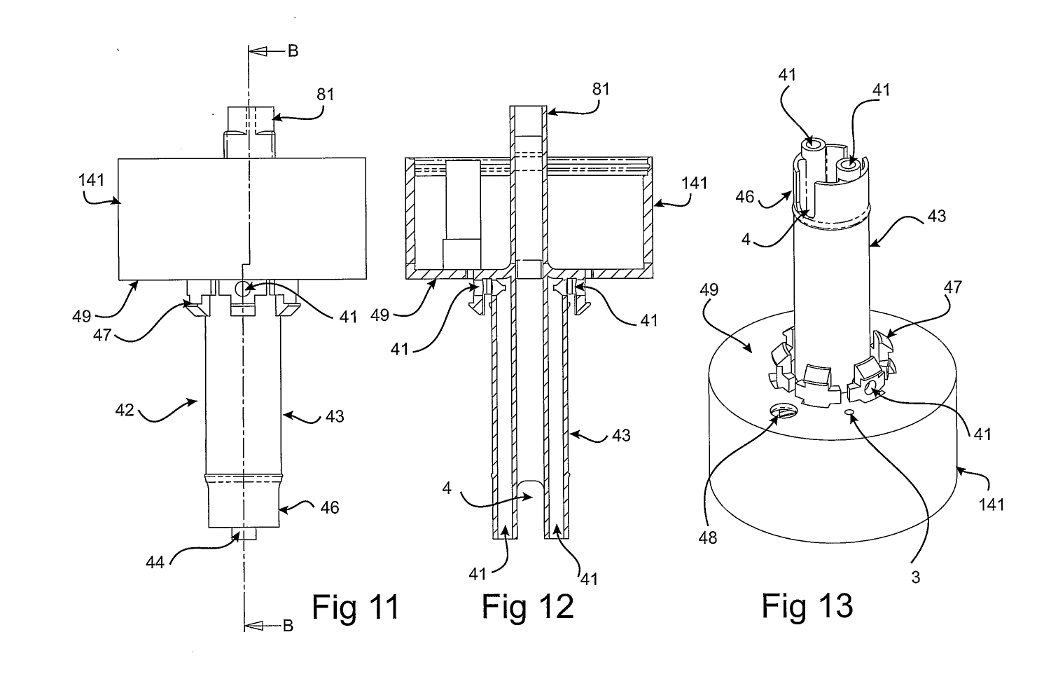

FIG. 9 shows a sectional view of FIG. 8 along section A-A;

FIG. 10 shows an isometric view of a body of the lockable cap of FIG. 3;

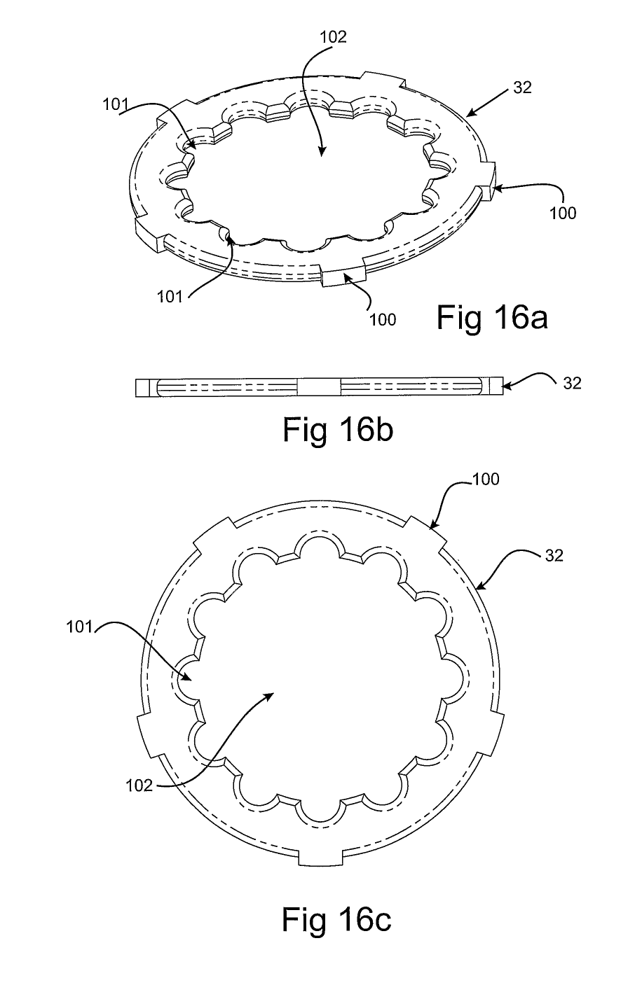

FIG. 11 shows an isometric view of a body of the lockable cap of FIG. 4;

FIG. 12 shows a section view of FIG. 11 along section B-B;

FIG. 13 shows another isometric view of the body of the lockable cap of FIG. 4;

FIG. 14 shows a lower isometric view of a collar of the lockable cap of FIG. 3;

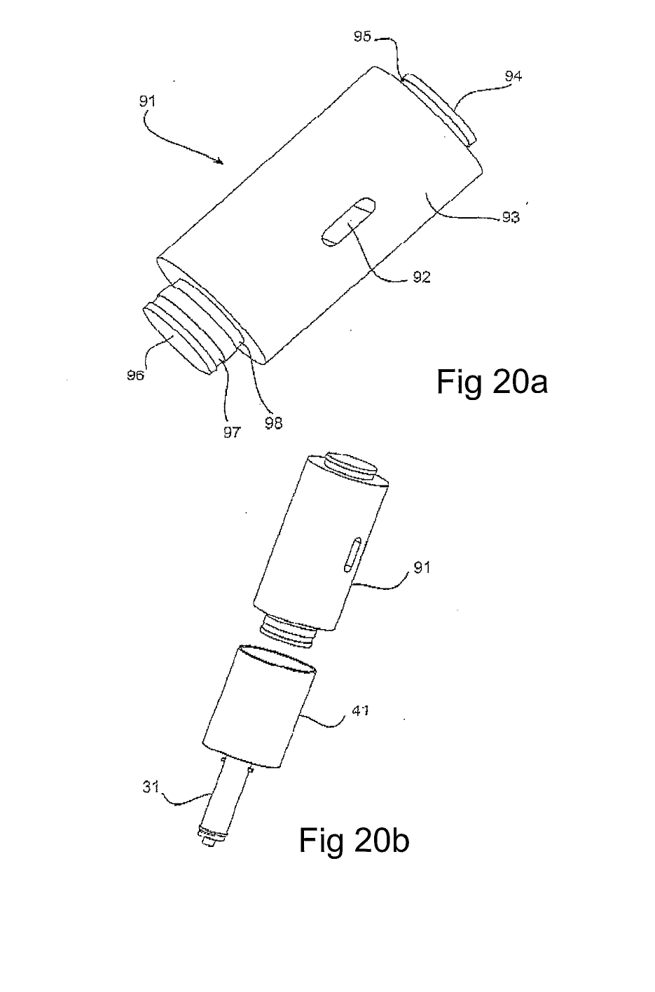

FIG. 15 shows an upper isometric view of a collar of the lockable cap of FIG. 3;

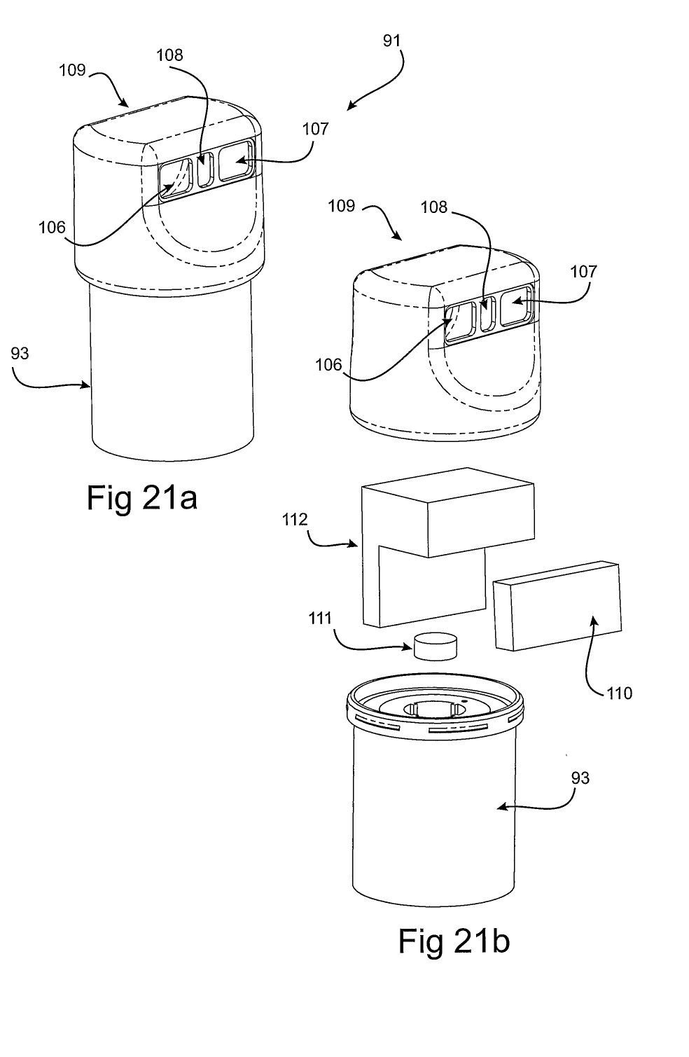

FIG. 16 shows isometric views of the collar of the lockable cap of FIG. 4;

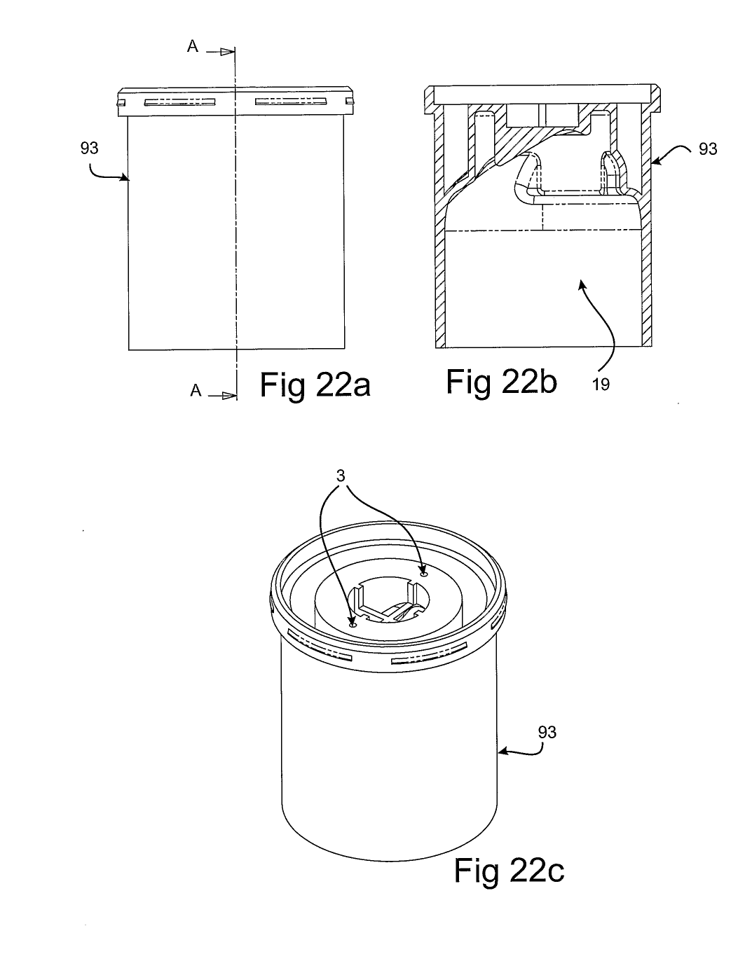

FIG. 17a shows an upper plan view of the clamp of the lockable cap of FIG. 3;

FIG. 17b shows a lower plan view of the clamp of the lockable cap of FIG. 3;

FIG. 17c shows a side elevation of the clamp of the lockable cap of FIG. 3;

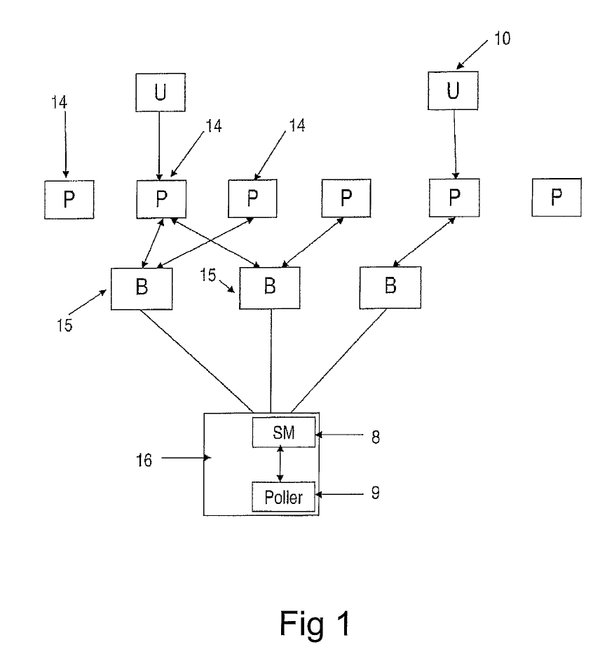

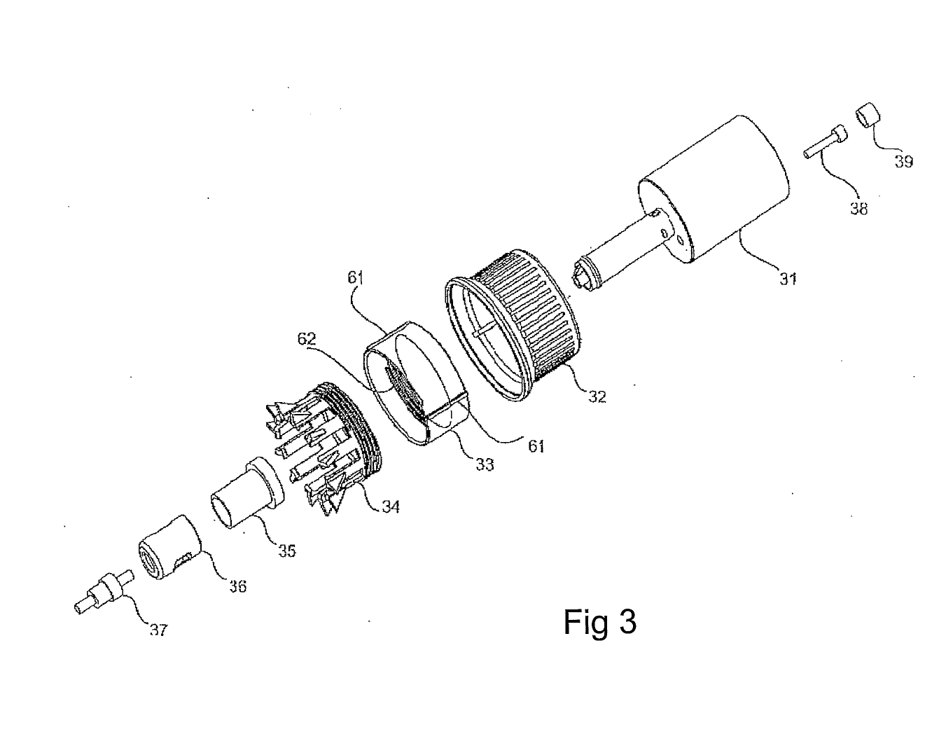

FIG. 1 7d shows an upper isometric view of the clamp of the lockable cap of FIG. 3;

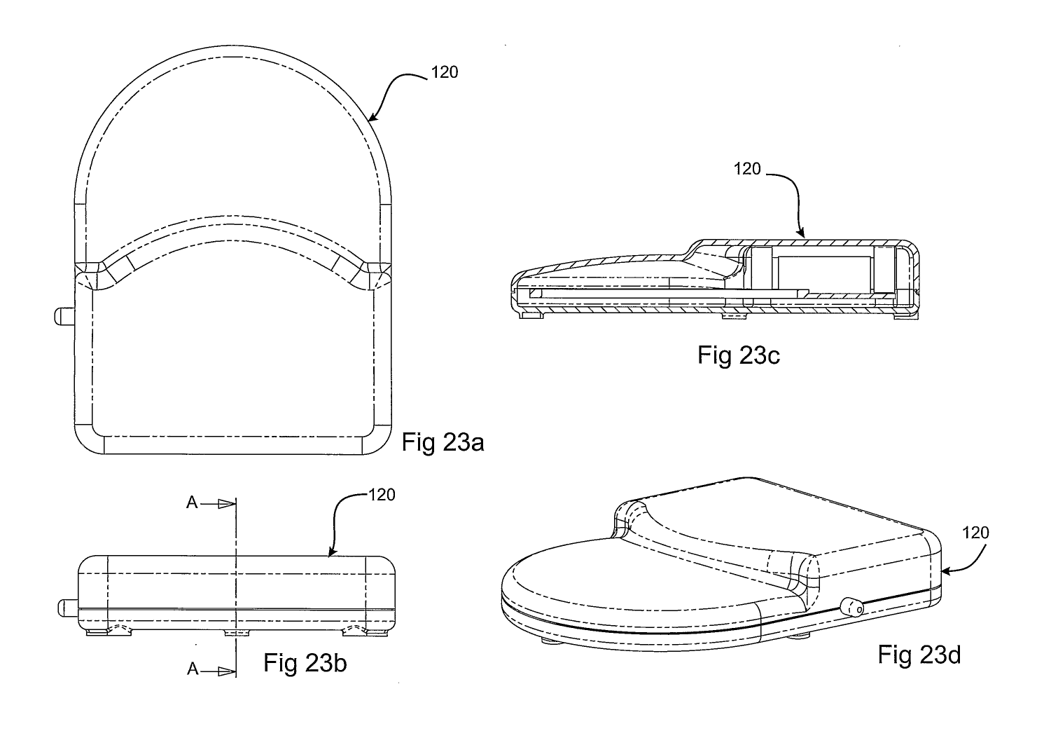

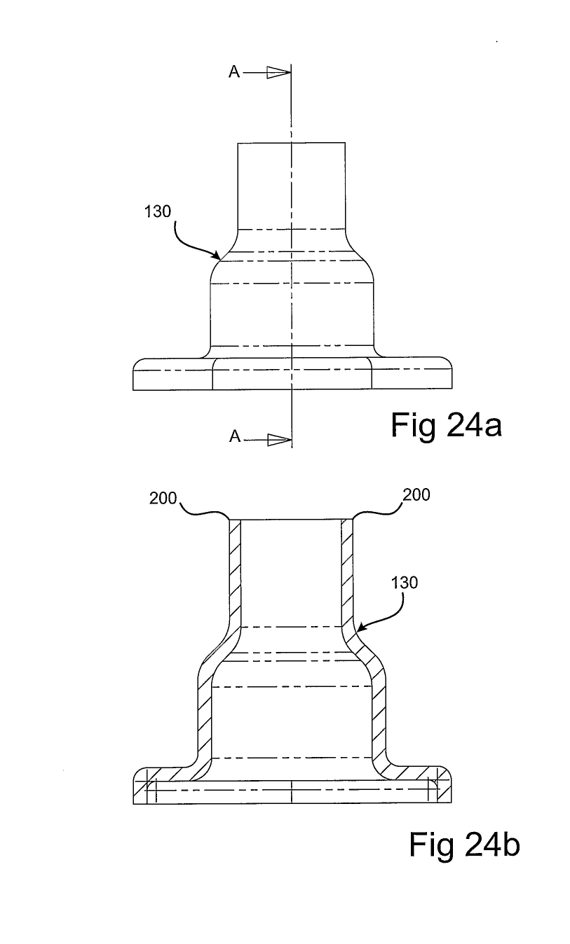

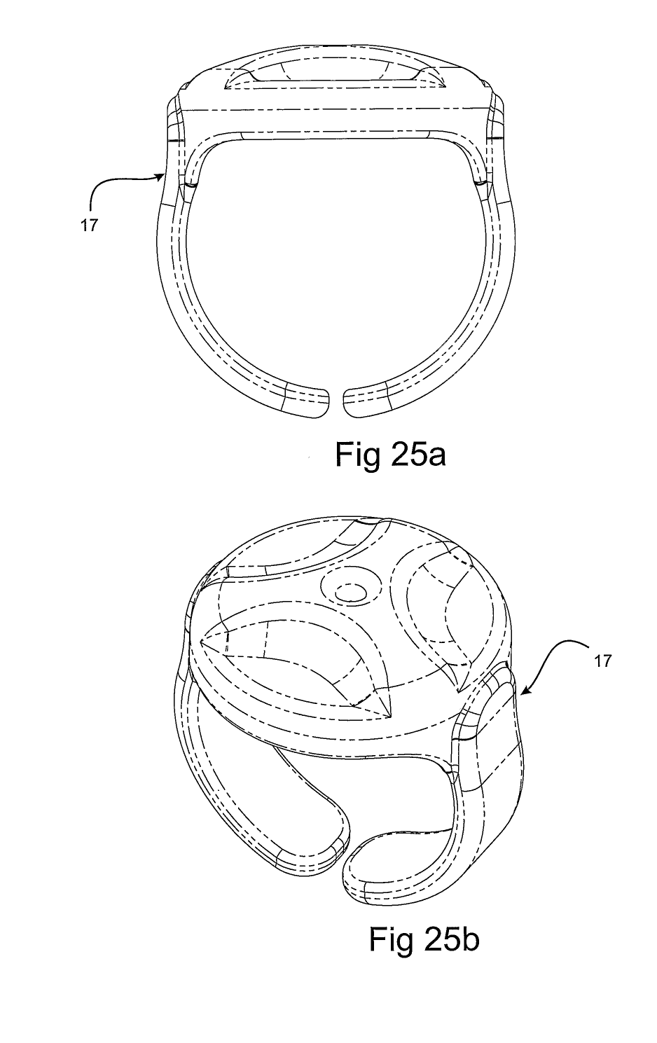

FIG. 17e shows a lower isometric view of the clamp of the lockable cap of FIG. 3;

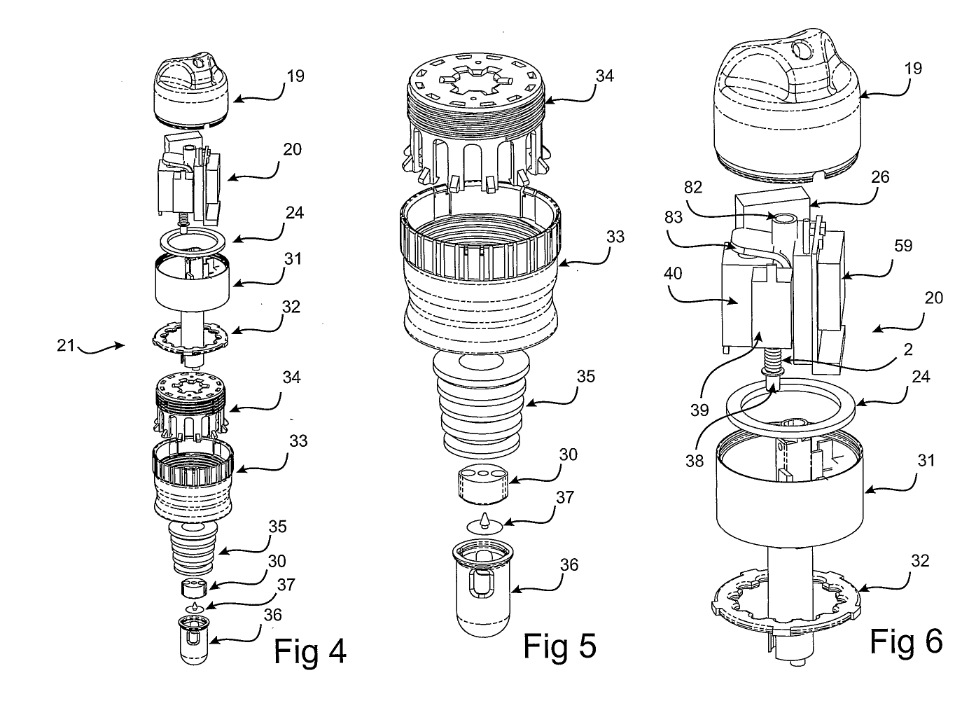

FIG. 18a shows an upper plan view of the clamp of the lockable cap of FIG. 4;

FIG. 18b shows an isometric view of the clamp of the lockable cap of FIG. 4;

FIG. 1 8c shows a sectional view of FIG. 18b along section A-A;

FIG. 18d shows an upper isometric view of the clamp of the lockable cap of FIG. 4;

FIG. 18e shows a lower isometric view of the claim of the lockable cap of FIG. 4;

FIG. 19a shows an upper plan view of the slide of the lockable cap of FIG. 4;

FIG. 19b shows an isometric view of the slide of the lockable cap of FIG. 4;

FIG. 19c shows a sectional view of FIG. 19b along section A-A;

FIG. 19d shows an upper isometric view of the slide of the lockable cap of FIG. 4;

FIG. 19e shows a lower isometric view of the slide of the lockable cap of FIG. 4;

FIG. 20a shows an isometric view of the scanner of a further embodiment of the present invention;

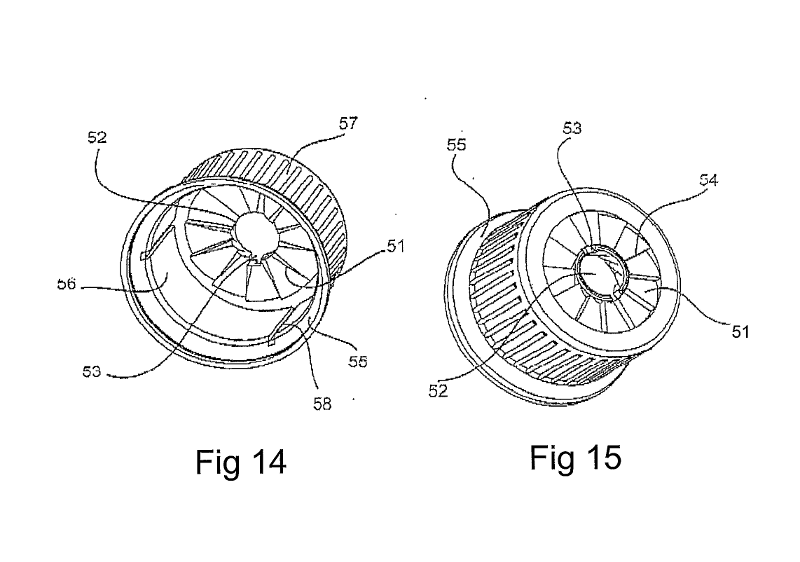

FIG. 20b shows an isometric view of the scanner of FIG. 9a in association with a pourer body;

FIG. 21a shows an isometric view of an alternative scanner in a further embodiment of the present invention;

FIG. 21b shows an exploded isometric view of the scanner of FIG. 21a;

FIG. 22a shows a plan view of the base of the scanner of FIG. 21a;

FIG. 22b shows a sectional view of FIG. 22a along section A-A;

FIG. 22c shows an isometric view of the base of the scanner of FIG. 21a;

FIG. 23a shows a plan view of a base station RFID reader according to an embodiment of the present invention;

FIG. 23b shows an isometric view of a base station RFID reader according to an embodiment of the present invention;

FIG. 23c shows a sectional view of FIG. 23b along section A-A;

FIG. 23d shows an upper isometric view of the RFID reader of FIG. 23a;

FIG. 24a shows a plan view of a battery charger unit according to an embodiment of the present invention;

FIG. 24b shows a sectional view of FIG. 24a long section A-A;

FIG. 25a a show a plan view of a further arrangement of the personal identification unit of an embodiment of the present invention;

FIG. 25b shows an isometric view of FIG. 25a;

### DETAILED DESCRIPTION OF PREFERRED EMBODIMENT

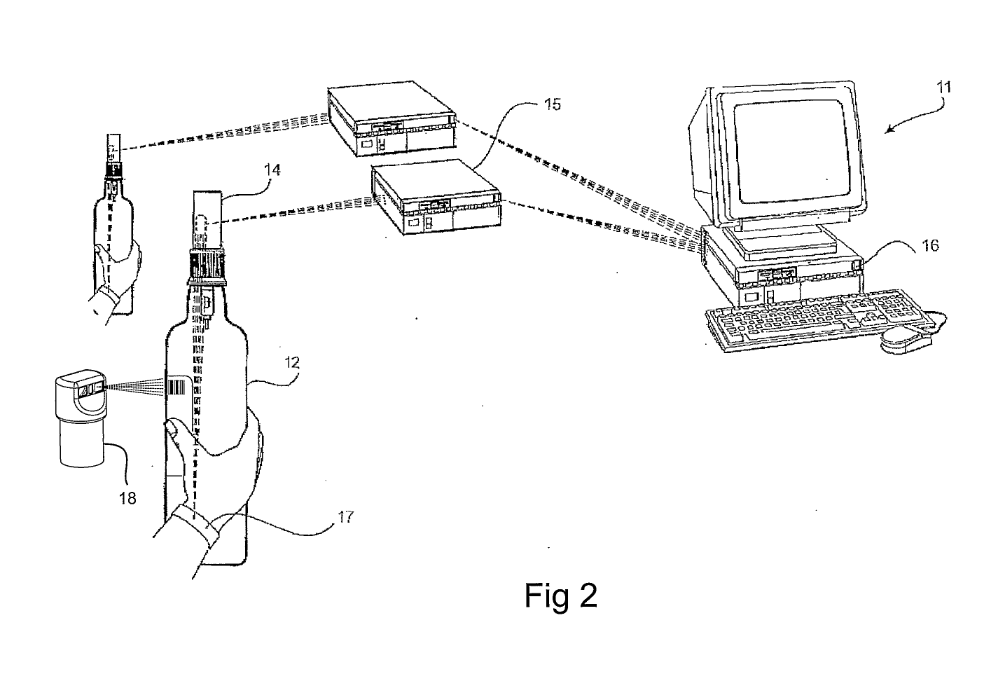

A first embodiment of a beverage control system 11 according to the invention is discussed with reference to FIG. 1 and FIG. 2. In general terms, the system 11 of the preferred embodiment is adapted to provide detailed control and tracking of the dispensing of beverages from a beverage container 12 such as a bottle. For example, the pouring of spirits in a bar. Briefly, the system 11 provides pourers 14 that lock onto the top of the bottles 12. The pourers 14 include a means to control the dispensing of beverage from the bottles 12. The control means is activated by remote base stations 15 when the base stations 15 are signalled that an authorised person is attempting to pour the beverage.

An authorised user 10 has a personal identification unit 17 such as a radio frequency identification (RFID) tag in the form of a ring worn on a finger of the authorised user 10 or another such device, for example a bracelet. The personal identification unit 17, identifies each authorised user 10 and could also identify their individual pourer profile. To start the process of pouring a beverage, the beverage container 12 is lifted from its storage position and tilted. The tilting may be sensed by a tilt sensor which can form part of the electronics package 20. When the hand of the authorised user 10 wearing the personal identification unit 17 comes in close proximity to a, a sensor 59 within the pourer 14 of a beverage container 12, the pourer senses the personal identification unit 17 and sends a signal which is detected by the base station 15. The signal may be received by more then one base station 15. A base station 15 will identify the user 10 and respond to the pourer 14; the response is dependent upon the user's 10 pourer profile and will either allow the user 10 to pour a pre-determined amount of beverage or allow a freepour.

Once a pour has been completed the pourer 14 will transmit to the base stations 15 the amount of beverage dispensed from the beverage container 12. The signal may be received by more than one base station 15, each pourer 14 has a unique pourer ID to allow the system 11 to identify any duplicate signals sent to each of the base stations 15 and appropriately deal with them.

The server 16 could connect to the base stations 15 to periodically request pourer 14 activity and send configuration information to the base stations 15 if necessary. The server 16 can also be used as the interface for the system 11 to allow a manager to enter configuration data or propagate the data to the base station 15. In the preferred arrangement these tasks may be divided between a poller 9 and a system manager 8.

As shown in FIG. 2, the beverage control system 11 of the preferred embodiment includes:
a lockable pourer 14 secured to a beverage container 12 such as a bottle containing alcoholic spirit;
a base station 15;
a base station radio frequency identification (RFID) reader 120;
a server 16;
a personal identification unit 17 to identify the person pouring the beverage; and
a container scanner 18.

The system ideally also includes a charger 130.

As is discussed in detail below in the preferred embodiment, the lockable pourer 14 includes a cap 21 lockably secured to the container 12 to thereby seal the container 12; an electronics package 20 including a beverage dispensing controller 23 having a valve 40, 83 to provide control of the dispensing of the beverage through the pourer 14; a temperature sensor to determine the ambient temperature; and an accelerometer to detect changes in acceleration of the beverage being dispensed; an infra-red sensor 7 to allow the pourer 14 to communicate with the container scanner 18; a tilt sensor to determine the orientation of the beverage container 12; an indicator LED; a reed switch to allow the scanner 18 to lock and unlock the pourer 14; a battery 26 to power the pourer 14; and a transceiver associated with the beverage dispensing controller for communication of signals associated with the control of the dispenser. For added security, the system may be configured such that the lockable cap 21 can only be unlocked by an authorised person.

The personal identification unit 17 is a passive RFID (Radio Frequency Identification) tag embedded in an item worn or held by the person authorised to dispense the beverage (hereinafter termed “the barman”). In one embodiment, the RFID tag is held within a wristband worn by the barman. The proximity of the barman is detected by a sensor 59 within the pourer 14 and an identification signal transmitted to a base station 15. When the base station 15 receives the identification signal it transmits a control signal to the pourer 14 enabling beverage to be dispensed. This ensures that beverage may only be dispensed by a barman and not by a customer or other unauthorised person.

In the preferred embodiment the personal identification unit 17 may also be a RFID tag held within a ring worn on one finger of a hand used to hold the bottle to dispense liquor. A possible ring is shown in FIGS. 25a and 25b. Other identification means may be used, such as a biometric scanner although the preferred system users RFID.

The system does not require any power supply within the ring (or wristband) and therefore does not need to be recharged. The ring is unobtrusive but also needs to be closely positioned to the pourer 14 when beverage is being dispensed. As a result the sensitivity of the sensing system can be set relatively low thereby avoiding identification signals being sent at an inappropriate moment. The beverage control system 11 will ordinarily be provided with a container identification means. The container identification means will typically be a cordless barcode scanner 18 which can be used to read the barcode of a new beverage container 12 at the time the beverage container 12 is initially opened and the pourer 14 secured to it. The scanner will signal to the server 16 either directly or via a base station 15 or via a pourer 14 the identity of the beverage container 12 according to its barcode. This can be referenced against the pre-determined data held in the server 16.

The preferred scanner 18 is roughly a cylindrical pocket sized device that ideally fits over the top of the pourer 14. It contains a barcode scanning module to scan beverage container 12 labels and an IR module to communicate with the pourer 14 that it is currently mated with. The scanner 18 also contains a permanent magnet that triggers the reed sensor on the pourer 14. The scanner 18 can be powered by a lithium polymer battery.

A charger may be a simple cylindrical device that is powered by an external DC transformer. Its function is to recharge the batteries in pourers 14 and scanners 18 when placed on top of the respective device. This recharging can be achieved by induction.

With reference to FIG. 3, the lockable cap 21 ideally includes:

a body 31;

a collar 32;

a slide 33;

a clamp 34;

a seal 35;

a sleeve 36;

a vent valve 37;

a locking pin 38; and

an electromagnet 39.

The body 31 includes a housing firstly acting as the main stopper component, secondly providing the fluid pathway and thirdly housing the beverage dispensing controller 23 and the transceiver 25.

With reference to the figures the body 31 includes a cylindrical housing portion 141 and a duct portion 42. The cylindrical housing portion 141 houses the locking pin 38 and an electromagnet 39, as well as the beverage dispensing controller 23, the transceiver 25 and the battery 26 which will be described later.

The beverage dispensing controller 23 in a preferred arrangement contains a latching pinch valve solenoid that controls the flow of beverage.

The duct portion 42 of the body 31 includes an outer duct 43 extending from the container side (the lower side) of the body 31 and an inner duct 44 which may be concentric with the outer duct 43 and thereby provide an annular space 45 between the outer duct 43 and the inner duct 44, the inner duct 44 extending slightly longer than the outer duct 43 to thereby protrude beyond the outer duct 43. The outer duct 43 is provided with a small stop-flange 46 about its periphery proximate its lower end. The outer duct 43 is also provided with a pair of opposed tags 47 extending radially outwardly from its perimeter proximate the housing portion 141.

The inner duct 44 is open through the housing to atmosphere to provide a pathway by which air may enter the container as beverage is removed. A conventional check valve 37 engages the lower end of the inner duct 44 to prevent beverage escaping through the inner duct 44. In a preferred arrangement the check valve may be an umbrella valve or any valve which allows one-way airflow.

The annular space 45 provides the pathway for beverage to pour through the body 31; as described later.

An aperture 48 is provided in the base 49 of the housing portion 141 to receive the locking pin 38.

The collar 32 includes a substantially squat cylindrical cap-like device, open at the lower end, and closed at the upper end 51 other than a central collar-aperture 52 to receive the outer duct 43 of the body 31. A pair of opposed slots 53 extend outward from the inner perimeter of the upper end 51 defined by the collar-aperture 52. The slots 53 are adapted to permit the collar 32 to be slid past the tags 47 on the outer duct 43.

The upper end 51 of the collar 32 is provided with teeth formations 54 in the manner of radial serrations. The teeth formations 54 cooperate with the locking pin 38. In use, the collar 32 abuts the base 49 of the housing portion 141. The locking pin 38 is pressed against the upper end 51 of the collar 32 through aperture 48 by a spring (not shown). As the collar is rotated in a first direction to lock the locking cap 21 to the container 12, the locking pin 38 slides up the angled face of a tooth formation, dropping down to the next tooth formation after a tooth edge Is traversed. When the collar 32 is rotated in an opposite direction the tooth face at a tooth edge engages the locking pin 38, thereby preventing rotation and unlocking of the locking cap 21. When an authorised person is identified by means of a personal identification unit 17, the magnet 39 is energized to withdraw the locking pin from engagement and thereby permit the collar to be rotated to remove the pourer 14.

The lower end of the collar 32 is provided with a flared flange 55 to accommodate the engagement teeth of the clamp, as is discussed below.

On the inner surface 56 of the cylindrical portion 57 of the collar 32 are a series of axially oriented slots 58. These are adapted to receive corresponding ribs 61 on the slide 33, as is discussed below.

The outer surface of the cylindrical portion 57 is grooved so that it is more easily grasped and rotated by a user.

The slide 33 includes a relatively simple tubular component, having an outer diameter slightly smaller than the inner diameter of the cylindrical portion 57 of the collar 32. It is provided with axially disposed ribs 61 corresponding with and to be received by the axially oriented slots 58 in the collar 32. The ribs 61 and slots 58 enable the slide 33 to be rotated in conjunction with the collar 32 but to slide axially relative to the collar 32.

The inner surface 62 of the slide 33 proximate its upper end is threaded.

The clamp 34 is shown in greater detail in FIGS. 17a to 17e and includes a cylindrical rim 71 and a plurality of fingers 72 about the periphery extending parallel to the central axis in the lower direction from the rim 71. The outer surface of the rim 71 is threaded and adapted to engage with the threading on the inner surface 62 of the slide 33. The upper end of the clamp is substantially closed by an annular member 77 with a central aperture 79 to receive the outer duct 43. As for the collar 32, the central aperture 79 of the clamp 34 is provided with a pair of opposed slots 78 to permit the clamp 34 to be slid over the tags 47 on the outer duct 43. In use, the slots 78 are thereby positioned to be engaged by tags 47 so that the clamp 34 is prevented from rotating relative to the body 31.

A triangular buttress 73 extends radially outwardly from the external surface of each finger 72 proximate the lower end. The oblique edge 74 of each buttress 73 extends from a point substantially midway along the length of the finger 72.

A tooth formation 75 extends inwardly from the lower end of each finger 72.

It will be seen that, when the collar 32 is rotated, the slide 33 is moved axially relative to the clamp 34 as a result of the threaded engagement. When the slide 33 moves downward and contacts the buttresses 73, the lower ends of the fingers are displaced inwardly so that teeth 75 can engage flanges around the mouth of the container, to thereby securely lock the pourer 121 on the container 12.

In addition seal 35 is provided to prevent leakage of the beverage while the sleeve 36 secures the above components to the body 31 by pressing the sleeve 36 over the top of the small stop flange 46 on the outer duct 43.

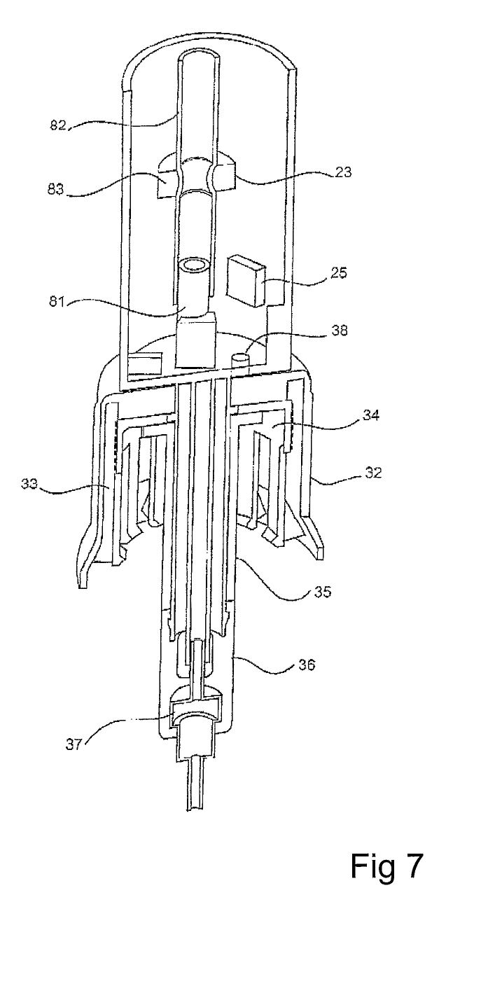

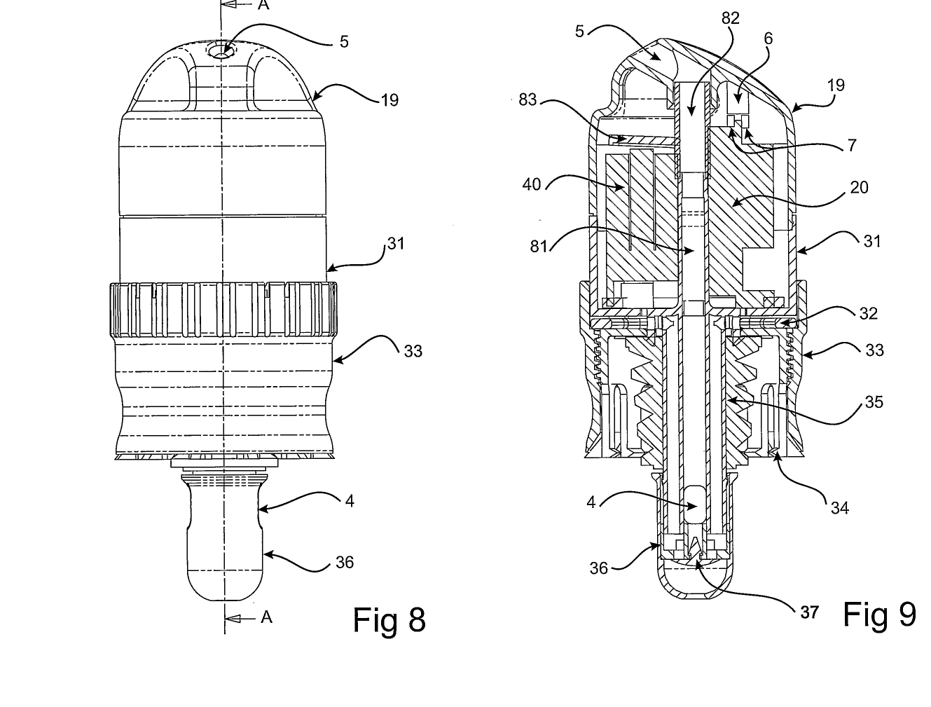

In a further arrangement, an alternative lockable cap 21 will now be described with reference to FIGS. 4, 5 and 6.

With reference to FIG. 4, the lockable cap 21 ideally includes:

a cap 19;

an electronics package 20;

a RFID coil 24;

a body 31;

a collar 32;

a slide 33;

a clamp 34;

a stopper seal 35;

an end cap 36;

a vent valve 37 and a vent valve holder 30.

The body 31 includes a housing firstly acting as the main stopper component, secondly providing the fluid pathway and thirdly housing the electronics package.

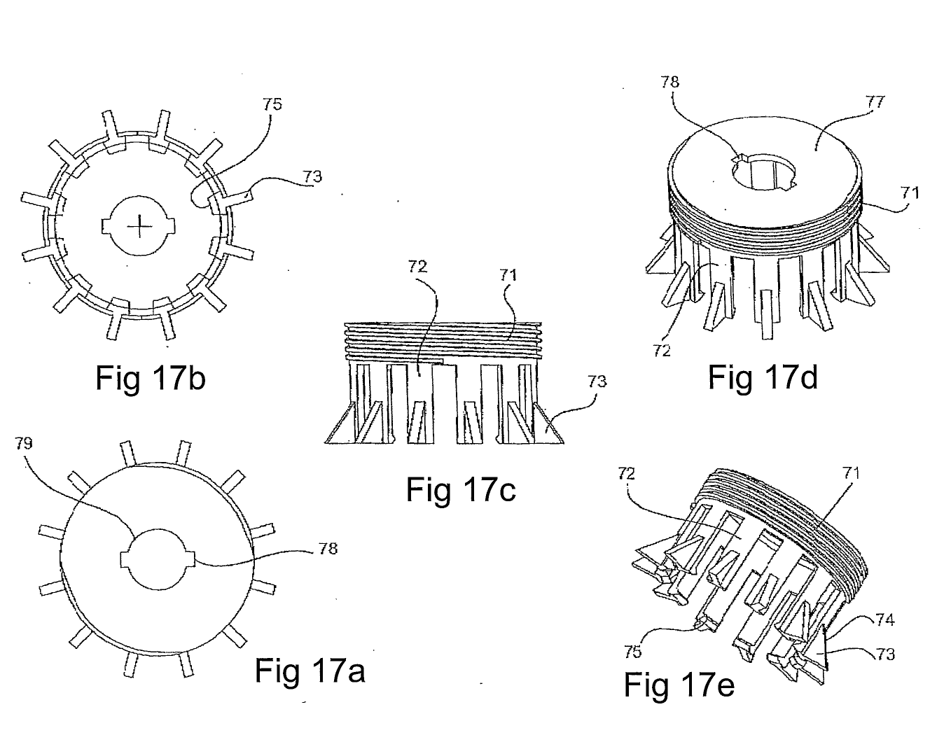

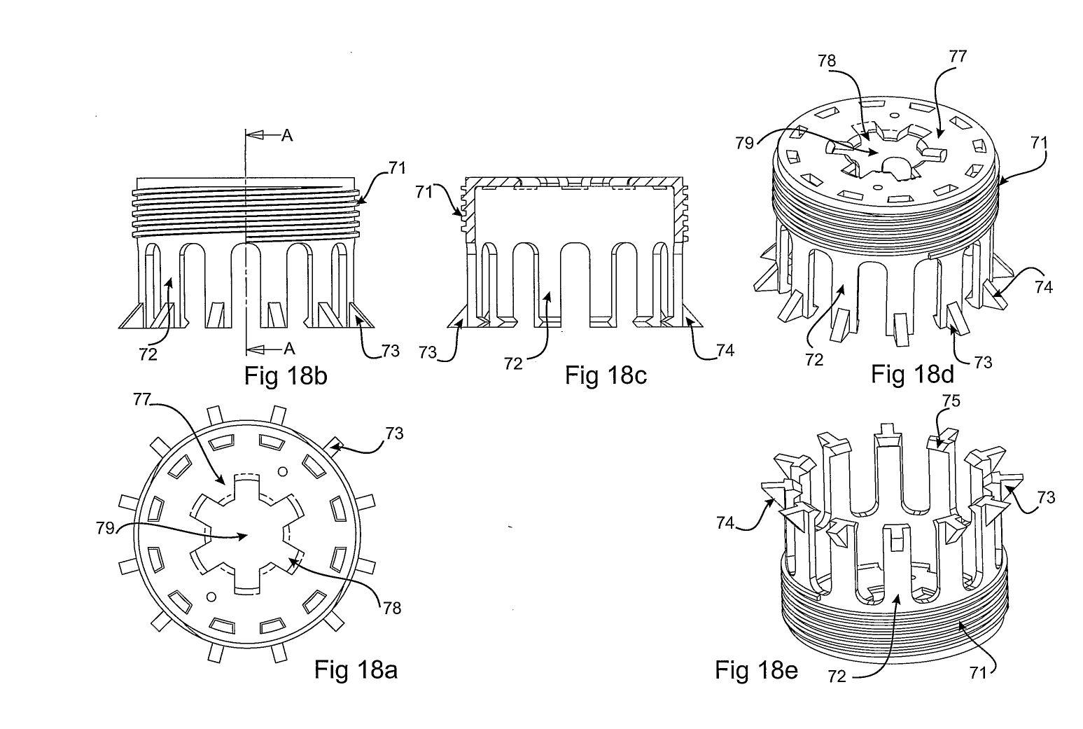

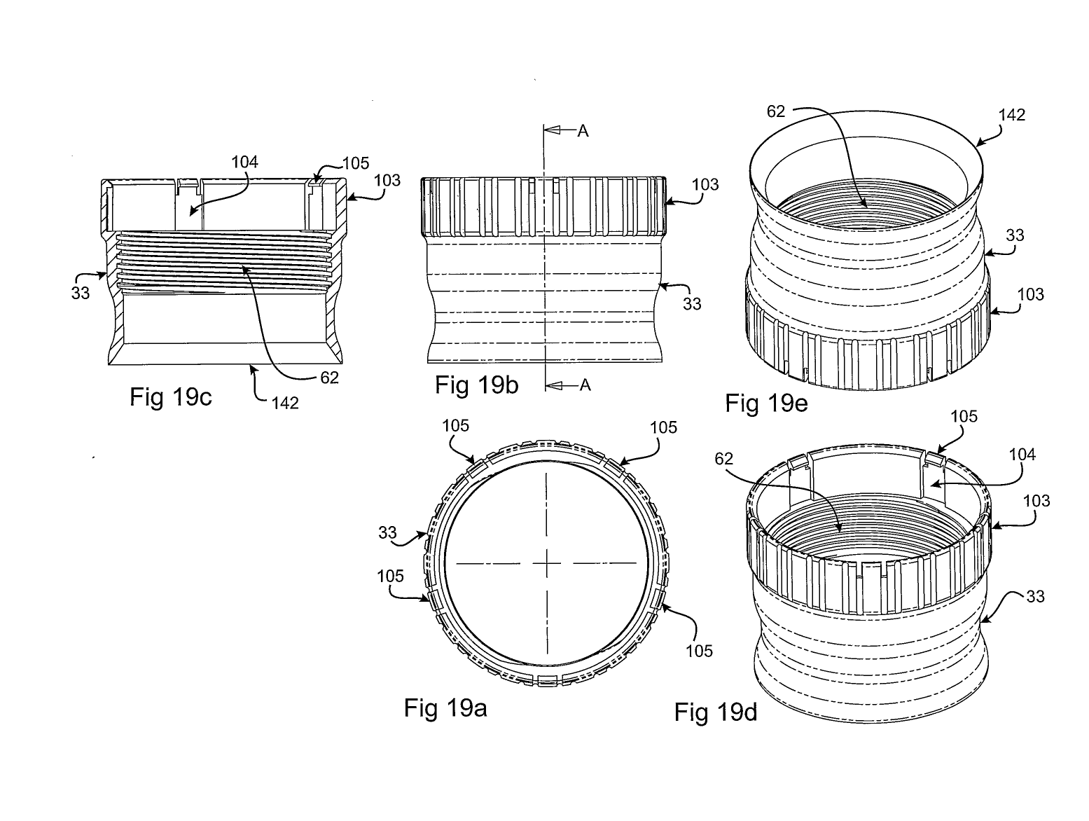

As seen in more detail in FIGS. 11, 12 and 13 the body 31 includes a cylindrical housing portion 141 and a duct portion 42. The cylindrical housing portion 141 houses the locking pin 38 and the electronics package 20. The electronics package 20 includes the beverage dispensing controller 23 which includes the pinch valve solenoid 40, the pinch valve rockerarm 83 and the flexible tube 82. The electronics package also includes the locking solenoid 39, the battery 26 and the RFID reader sensor 59. A cap 19 is placed on top of the cylindrical housing portion 141 to cover the lockable cap 21. The cap 19 includes an outlet 5 through which the beverage is dispensed.

The duct portion 42 of the body 31 includes an outer duct 43 extending from the container side (the lowest side) of the body 31 and two inner ducts located within the outer duct 43 forming two air intakes 41. The other end of the air inlet 41 is located on the locking tabs 47 and allow air to pass into the lockable cap 21. The outer duct 43 is provided with a small stop flange 46 about its periphery proximate its lower end. The locking tabs 47 extend from the housing portion 141. The air intakes 41 are open through the housing to atmosphere to provide a pathway by which air may enter the container 12 as beverage is removed. A conventional air valve 37 engages the lower end of the air intakes 41 to prevent beverages escaping through the air intakes 41. In a preferred arrangement, the air valve 37 may be an umbrella valve or any valve which allows one way air flow. An aperture 48 is provided in the base 49 of the housing portion 141 to receive the locking pin 38.

The collar 32 includes a substantially round plate like device having a central aperture 102 to receive the outer duct 43 of the body 31. Around the outer periphery of the collar 32 are a number of tabs 100 used to locate the collar 32 inside the slide 33. The central aperture 102 of the collar 32 has a diameter large enough to allow the collar 32 to be slid past the locking tags 47 extending from the bottom side of the housing portion 141. The edge of the central aperture 102 is defined by a number of semi-circular scallops 101 which cooperate with the locking pin 38. The locking pin 38 is located within the semi-circular scallops 101 through aperture 48 by a spring 2. The locking pin 38 must be removed from the semi-circular scallops 101 to allow the slide 33 to be screwed down onto the clamp 34 to lock the pourer 14 onto the beverage container 12.

The slide 33 includes a relativity simple tubular component, having an outer diameter slightly larger than the outer diameter of the collar 32. The slide 33 has a number of one way tabs 104 to receive the tabs 100 of the collar 32. The one way tabs 104 have a protrusion 105 extending from the top of each tab 104 to prevent the collar 32 from being removed from the slide 33. The inner surface 62 of the slide 33 proximate its upper end is threaded. The slide 33 on its upper outer surface 103 has a number of grooves so that it is more easily grasped and rotated by a user. The lower end of the slide 33 is provided with the flared flange 142 to accommodate the engagement teeth of the clamp 34, as is discussed below.

The clamp 34 is shown in greater detail in FIGS. 18a to 18e and includes a cylindrical ring 71 and a plurality of fingers 72 about the periphery extending parallel to the central axis in the lower direction from the rim 71. The outer surface of the rim 71 is threaded and adapted to engage with the threading on the inner surface 62 of the slide 33. The upper end of the clamp is substantially closed by an angular member 77 with a central aperture 79 to receive the outer duct 43. The clamp 34 is provided with a number of slots 78 to permit clamp 34 to be slid over the locking tags 47 extending from the lower side of the housing portion 141. In use, the slots 78 are thereby positioned to be engaged on the locking tags 47 so that the clamp 34 is prevented from rotating relative to the body 31. A triangular buttress 73 extends radially outwardly from the external surface of each finger 72 proximate the lower end. The oblique edge 74 of each buttress 73 extends from a point substantially midway along the length of the finger 72. A tooth formation 75 extends inwardly from the lower end of each finger 72.

It will be seen that, when the slide 33 is rotated and moved axially relevant to the clamp 34 due to the threaded engagements. When the slides 33 moves downward and contacts the buttresses 73, the lower ends of the fingers are displaced inwardly so that teeth 75 can engage flanges around the mouth of the container 12, to thereby securely lock the pourer 14 on the container 12.

In addition a stopper seal 35 is provided to prevent leakage of the beverage while the end cap 36 secures the above components to the body 31 by pressing the sleeve over the top of the small stop flange 46 on the outer duct 43. The end cap 36 further includes liquid intake openings 4 to receive the beverage to be dispensed from the container 12.

The transceiver 25 includes the sensor to sense the proximity of the personal identification unit 17 (ring) of a barman and also to send and receive signals to a base station 15. The beverage dispensing controller 23 includes a soft tubular member 82 extending from a spout 81 in fluid communication with the annular space 45. A control valve 83 is provided in the form of a magnetically controlled actuator which when closed clamps the soft tubular member 82 and when open permits beverage to pass through. In a preferred arrangement the control valve consists of a latching pinch valve solenoid that controls the flow of beverage. The beverage dispensing controller 23 also includes circuitry to be actuated when appropriately signalled by the base station 15 and to open the valve 83 for a pre-determined period thereby dispensing a specific quantity of beverage.

In a preferred arrangement the liquor volume poured is calculated by the pourer 14 from the following data:
Pouring time;
Kinematic viscosity, which is derived from a kinematic viscosity vs temperature table for the specific liquor, and the ambient temperature at the time of the pour. The ambient temperature can be sensed by the temperature sensor in the pourer 14.
Pressure exerted by the liquor in the bottle on the spout, adjusted for changes in acceleration of the bottle during the pour to compensate for pressure changes due to vertical bottle movement.

The tilt sensors can be arranged in such a way as to eliminate the possibility of the valve being opened (and hence a pour being recorded) when the bottle is not substantially inverted or the flow impaired.

The beverage dispensing controller 23 can be adapted to provide varying degrees of sophistication. In a first adaptation, a first tilt sensor is provided to sense when the container 12 is in an inverted orientation. Commercially available micro-sensors can detect when they are tilted more than a pre-determined angle, typically in the order of 55 degrees. A tilt sensor is therefore arranged to indicate when the container 12 is inverted or within the pre-determined angle. It then awakes the beverage dispensing controller 23 from its sleep mode in which little battery power is used. The beverage dispensing controller 23 then signals the RFID sensor to transmit a signal to identify a nearby RFID tag, being that of the barman. Once positive identification has been made, the beverage dispensing controller 23 transmits the required information to the base station 15, such information typically including the Identity of the pourer, the bottle, the identity of the barman and ambient conditions that may be sensed such as the temperature. The base station 15 processes the information to verify that a pour is appropriate and to determine the volume of pour to be given by accessing stored information taking into account the type of drink being poured and the ambient conditions, as appropriate. This time via a conversion within the pourer 14 is then signalled to the beverage dispensing controller 23, which opens the valve for the defined period.

In a further arrangement, a second tilt valve is provided, the second tilt valve being oriented in the opposite direction to the first tilt valve to thereby be able to sense when the container 12 is returned to an upright condition. When this occurs and is sensed by the second tilt valve, the valve is opened a second time for a short period (perhaps 1 second) by the beverage dispensing controller 23. In this time, remaining beverage in the soft tubular member 82 between the valve and the external mouth of the soft tubular member 82 is able to drain back into the bottle 12. In another preferred arrangement this is necessary in order to obtain very precise control of the volume dispensed which is required to satisfy regulatory authorities.

In addition, the existence of the second tilt valve enables the pourer 14 to dispense in a second mode. Instead of dispensing a determined quantity of beverage, the barman may wish to pour until the customer is satisfied, called a free-pour mode. The mode to be used will be dependent upon the barmans pourer profile which is associated with the personal identification means 17 (ring) the barman is wearing. The valve is opened when the first tilt valve signals that the container 12 has been inverted and the second tilt valve signals the end of the free-pour when the container 12 is upright.

The pourer 14 calculates the volume dispensed from the bottle 12 during a free-pour and sends this information to a base station 15 to determine the charge to be levied. Each pourer will be provided with a rechargeable battery in order to meet the power requirements of the pourer 14. These batteries will require regular charging in order to satisfy the drain on power. In a preferred arrangement the charging can be undertaken without disturbing bar operation, by charging provided by an induction method so that no electrical connection need be made directly to the pourer 14. Such techniques are known to those skilled in the art and similar principles to those used to charge electric toothbrushes could be implemented. The charger is arranged so that it is housed within a frame used to support the container 12 when it is idle, thereby ensuring that the pourer 14 is kept in a charged state. The beverage dispensing controller 23 incorporates circuitry to monitor the battery condition and to signal the base station 15 in the event that the voltage is excessively low.

In another arrangement the pourer 14 can be recharged by placing the pourer 14 on or over a contact type charger 130. The charger 130 can include contact elements 200 about the periphery of the top of the charger 130. The pourer 14 can then be placed over the charger 130 such that the base portion slides over charger 130 until pins protruding through holes 3 on the cap body 141 come in to contact with the charger contacts 200. As noted above the charger contacts may be a ring about the periphery of the charger 130 or alternatively are placed over the top of the charger 130. The charger contacts can then be connected to the battery terminals or another source of power to thereby enable the battery of the pourer 14 to be recharged. A pourer 14 attached to a beverage container 12 such as a bottle can remain in a low power ‘sleep’ mode until woken up by either a tilt sensor, which indicates a user would like to pour a drink, or the magnetic reed switch, which indicates that a scanner 18 is in close proximity. While inactive, the pourer 14 can wake itself up periodically (typically every hour) to send a ‘heartbeat’ message to the base station 15. The ‘heartbeat’ message tells the system that the pourer 14 is in good working order and indicates the battery level. If the battery level falls below a preset level an alarm is generated in the system manager located on the server 15 and an indicator LED on the pourer 14 can start to intermittently flash, indicating that the unit requires recharging. In the preferred arrangement the system may be configured such that only the pourer 14 can initiate communication with a base station 15. In some configurations a heartbeat message is also an opportunity for the base station 15 to respond with any system configuration changes for the pourer 14.

A pourer 14 may also be woken from ‘sleep’ mode by a scanner 18, the pourer 14 can use various communication protocols depending on the implementation form a data link via Infra Red (IR) communication with the scanner 18. The scanner 18 will be making either a lock request, in this case the barcode of the beverage container 12 in question will be sent to the pourer 14 or an unlock request in which case no additional data need be sent. The pourer 14 will then activate its RFID reader to determine the identity of the user holding the scanner 18 or pourer 14, and send such information to a base station 15. It is possible for the RFID reader in the pourer 14 to read the user's personal identification unit 17, for example a ring tag because the user has his/her hand wrapped around the scanner 18, which is in turn sitting on top of the pourer 14, bringing the ring tag 17 within range of the pourer's RFID reader.

Pourers 14 and base stations 15 communicate using a communication protocol that deal with issues such as packet collision, retransmission, duplicates and error checking.

The base station 15 that receives the lock/unlock request looks up the user from the personal identification unit 17 (RFID tag ID), looks up the product from which the pourer 14 is associated with from the barcode, and from these two sets of attributes, along with a set of configured business rules, determines the correct response which is sent back to the pourer 14. In the case of a successful lock request, the pourer 14 is associated with the supplied barcode and the solenoid (which will be described below) that controls the locking mechanism of the pourer 14 will be activated. A successful unlock request performs the reverse; the pourer 14 is disassociated from the barcode, and the mechanism is unlocked allowing removal of the pourer 14 from the beverage container 12.

In operation when a pour request is required it causes the RFID reader in the pourer 14 to read the personal identification unit 17 (ring tag) of the bartender, whose ID is sent to the base station 15 along with other data such as the beverage container 12 barcode. The base station 15 uses the tag ID and barcode to determine whether the pour request should be authorised and if so whether it is a freepour or a set portion size. If the portion is a set size the pinch valve (described below) will be opened only until the specified amount of liquor has been dispensed. If freepour, the valve will remain open until the bottle is no longer inverted. When the pour has completed, a pour update is sent to the base station 15 indicating the amount of liquor that was dispensed. If a pour takes longer than 60 seconds, then the system could be configured so that an interim pour update will be sent every 60 seconds to the base station 15.

If a response has not been received from the base station 15 within a preset amount of time, a failsafe can be configured to deliver a preset portion size.

The base stations 15 include computer systems having communication means to communicate with one or more pourers 14. In a typical arrangement, the base station includes a microcontroller with a number of peripherals including, a WiFi card, connected to a radio transceiver via serial connection. The base station 15 uses the radio transceiver to communicate wirelessly with the pourers 14, and the WiFi card to communicate with other base stations 15 and the server 16. The base station 15 responds to pour and lock/unlock requests from the pourer 14, and stores pourer activity information. The base station 15 sends the pourer activity data to the poller 9 via WiFi or Ethernet using TCP/IP protocol. The base station 15 also receives configuration data such as user information, location information and global settings from the poller 9 via the WiFi or Ethernet. The base station 15 software is completely stand-alone, and does not require a connection to the server 16 for normal operation. Three base stations 15 would normally be located within each coverage area to provide a fault free operation even in the unlikely event that a single unit were to fail.

In a preferred arrangement a base station RFID reader is a device that connects to a base station 15 via a RS232 serial cable. It is used by the system manager to read a personal identification unit 17 (ring tag ID) so that a physical ring tag can be associated with a particular employee.

As stated above the function of the base station 15 is to act as a go between for the pourers 14 and system manager/poller located on the server 16. Since system manager/poller reside on a server, there is no guarantee that these resources will be available all the time. The system manager 8 is the interface that is used to enter configuration data, and the poller 9 is responsible for propagating this data to the base stations 15. Once configured the base stations 15 operate independently, receiving and responding to pourer 14 requests without the need for any additional resources or connectivity. This ensures no interruption to normal bar operations in the event of a network or server 16 failure.

In a preferred arrangement the base station 15 is a server type device. In other words, it does not initiate connections to other devices, it only responds to them. For example a request may include of one of the following:

| From | Transport method | Request types |
|---|---|---|
| Pourer | Communication | Pour request, pour report, |
| | protocol over | lock, unlock, heartbeat |
| | UHF wideband | |
| | FM wireless | |
| Poller | TCP/IP over | Receive configuration |
| | Ethernet or WiFi | data, send activity data |
| System | UDP/IP over | Scan ring tag ID from RFID |
| manager | Ethernet or WiFi | reader module |

All of the above request types use application level protocols developed specifically for the beverage control system 11.

The poller will now be described in relation to the beverage control system 11 of a preferred arrangment. Configuration data from the poller 9 can include data in relation to users, inventory, or general configuration of the beverage control system 11.

Periodically, the poller 9 will connect to each base station 15 and request a list of all pourer 14 activity since the last request. In a preferred arrangement there will usually be multiple base stations 15 in each wireless coverage area for redundancy, it is possible (in fact probable) that activity data from one base station 15 will contain one or more duplicate events—that is, a pourer 14 transaction that has already been received from another base station 15. A poller uses a unique pourer 14 event ID to eliminate these duplicates as each event is imported into the master transaction database located on the server 16.

In a further preferred arrangement the poller 9 additional responsibilities include maintenance and regular predetermined data removal from the system transaction database, automatic generation of scheduled reports and the automatic running of scheduled data imports and exports from and to 3^{rd} party software applications.

The data import and export is carried out by the poller 9, completely independent of the system manager 8. The system manager 8 determines when the poller 9 will import and export information. The system manager 8 provides the poller 9 with scheduling information to carry out the import and export of data.

The server 16 includes a computer system which controls and manages the system 11. In one embodiment, the server 16 is simply a front-end interface for the user to configure the system, store pre-determined data such as the barman's name, and their pourer profile, and record the data that is produced. In a preferred arrangement the server 16 houses the system manager 8 and also the poller 9. In a further arrangement the poller 9 is a windows service application that runs in the background on a separate server that can be networked with the server 16 housing the system manager 8. The system manager 8 is a windows forms application that is the user 10 interface to the system. The system manager allows the user 10 to configure every aspect of the system including pourers 14, base stations 15, user access levels, inventory attributes, imports (user, inventory and POS) and exports (user, inventory and access) data to other 3^{rd} party applications and generates reports. All configuration data is held on the server 16, and any changes made by the user 10 are automatically propagated to all base stations 15 by the poller 9 via WiFi or ethernet. A base station 15 will store all activity data locally until the poller 9 periodically polls the base station 15, at which time it will transfer the data via the poller 9 to the server 16. The server 16 only needs to be on in order to make configuration changes or access the usage data produced by the system 11. Thus a server 16 failure will not impact the normal operation of the bar. In another preferred arrangement the system manager 8 is now described in relation to the beverage control system 11 the system manager 8 (“SM”) is a Windows forms application that is the front end interface to the system 11 for the user 10. It operates in either manager mode or admin mode. Admin mode is started by entering the admin password, and simply provides access to additional configuration and reporting functionality. Admin mode is for the IT manager or system installer, whereas manager mode is for the bar manager who is usually a non technical person.

In a further preferred arrangement of manager mode, there are 4 configuration screens available—users, inventory, activity and reports. Admin mode adds global settings, locations, base stations, imports, exports and spouts (spouts is the SM name for pourers 14).

The user screen allows the manager to add, remove and edit users. As an example user records may contain the following information:

| Field | Description |
|---|---|
| First name | Users first name |
| Last name | Users last name |
| Server | Yes - user can pour, No - user cannot pour |
| Bar Back | Yes - user can lock/unlock, No - user cannot lock/unlock |
| Freepour | Yes - Permit freepours, No - fixed portion size. Note this can |
| | be overridden for specific products. |
| Pour guide | Yes - display a visual indicator (LED flash) every 10 ml, No - |
| | no indicator, Freepour - only show indicator when freepouring |

The user screen also displays the ‘scan tag’ button. The scan tag button allows the manager to associate a user with a personal identification unit 17 (ring tag), and to select the user from the user list. A manager may select the ring tag reader to use from the combo box (these are all the serial ports defined as type TAGR in the base station 15 configuration screen), then click ‘scan tag’. SM establishes a link with the selected tag reader via the base station 15 that the reader is connected to, using a user datagram protocol (UDP). When the personal identification unit 17 (tag) has been read, the tag ID is associated with the selected user in the user database. This database change in turn causes the poller 9 to propagate the new tag information to each base station 15.

The inventory screen allows the manager to add, remove and edit inventory items. As an example each inventory record may contain the following information:

| Field | Description |
|---|---|
| Barcode | Barcode of the product |
| Name | Human readable product name |
| Unit size | Volume of the bottle in mL |
| Unit cost | Cost of the bottle without decimal (ie 1000 = $10 in Australia) |
| Shot size | 0 = use default shot size defined in global configuration, non- |
| | 0 = override |
| Viscosity | Number of mS taken to dispense 1 mL of the liquor |
| Allow | No = ignore user ‘Freepour’ setting and deliver only |
| freepour | fixed portions |

The system 11 is supplied with a default master inventory list that can be referenced when adding an inventory item. The master list contains barcode, name, unit size and viscosity information for about 1,000 of the most popular brands of liquor.

Before the system can accurately measure dispensed volumes for a given liquor, it must be calibrated to determine a viscosity value for that liquor. In a preferred arrangement this is achieved by clicking the ‘calibrate’ button on the edit/add inventory item screen. The user is stepped through a simple procedure that involves pouring 3 separate amounts of the liquor in question, and reporting the amount of liquor dispensed in each case. The system manager 8 compares the data with a theoretically calculated volume to determine the actual viscosity factor.

The activity screen is a monitoring and diagnostic tool. Every human generated event in the system 11 (pour, lock, unlock) is displayed in real time, along with supplementary data that indicates the outcome of the event (success or failure, how much liquor was poured etc). This data can be used to spot system and user-level problems as they occur.

The reports screen allows the manager to define and schedule reports. Reports can be run automatically at defined intervals (daily, weekly, monthly) and can cover any reporting period required. Reports can also be run immediately on an adhoc basis for immediate viewing. Generation reports can be automatically printed, emailed or saved to a folder for later viewing. Reports are generated in the popular PDF format for widest possible compatibility. Many reporting options are available such as reporting by user or inventory, by location or location groups and specific time intervals.

The Global settings allow the manipulation of several low level installation-specific parameters. An example of some parameters are displayed as follows:

| Parameter | Description |
|---|---|
| Enable | Yes = normal mode, bartender ID is read for |
| authenti- | authentication. No = ignore RFID tags. |
| cation | |
| Default | Standard portion volume where not overridden by a |
| poursize | specific inventory item setting. |
| Failsafe | Action to take if no base station response to a pour |
| timer | request (ie system failure). A non-zero value will cause |
| | the liquid valve in the pourer to dispense the configured |
| | amount of liquor. |
| Heartbeat | Timer interval between heartbeat packets sent by |
| interval | pourer. Pourers default to 5 seconds so that they |
| | quickly get their system configuration on power up, but |
| | a more typical value would be once an hour. |
| Radio RX | Millisecond to wait after a radio transmission (pour, |
| timer | heartbeat, lock, unlock request) before retrying. |
| Radio TX | Number of times to retry transmission before initiating |
| retries | failsafe timer action. |
| Pour | Millisecond between pour update transmissions for |
| report | long pours, defaults to 60,000 (1 minute). |
| interval | |
| Base poll | Number of seconds between each base station 15 poll |
| interval | by poller 9 to collect activity data (does not apply to |
| | configuration updates which are sent immediately). |
| SMTP | Internet address of outbound mail server for emailing |
| server | reports. |
| Allow | The default action is to return an error if a user |
| unknown | attempts to scan or pour a product that is not in the |
| products | inventory database, however setting this parameter to |
| | Yes causes the request to be processed successfully |
| | and the new product to be automatically added to the |
| | inventory database. Where a product is added in this |
| | way SM 8 will warn that there is a product in the |
| | system that is missing some data (such as unit cost, |
| | volume and viscosity) and prompt the user to manually |
| | enter it. Generally this mode is only used where the |
| | system is not importing inventory data from a separate |
| | inventory system. |
| Trans- | Number of days to retain activity data (any transactions |
| action | older than this are regularly purged from the master |
| retention | transaction database by poller 9). |
| Lowest | When adding a new user, SM 8 automatically assigns a |
| user ID | unique integer-type ID. Setting this value guarantees |
| | that no ID number below this value will be used. This |
| | is useful for preventing user ID conflicts where user |
| | data is imported from an external system such as |
| | payroll that assigns it's own IDs to users. |
| Config | System manager 8 password to access admin screens |
| password | |
| Base | Password used between poller 9 and base stations 15. |
| password | |
| Default | If a user attempts to pour a product that is not in the |
| pour | inventory database or has no pour viscosity data |
| speed | associated with it, this value will be used. Since it will |
| | only be approximate it will result in slightly inaccurate |
| | reported volumes, and where this is the case it is |
| | indicated in any reports that are generated. |
| Volume | mL or fl. Oz depending on the region. |
| units | |
| Low | Minimum pourer 14 battery volts level before a low |
| battery | battery alarm is triggered. |
| warning | |

The Locations screen is where the installer can define the physical serving areas. Locations are related to activity by specifying a location for each base station 15 in the base stations configuration screen. As an example the locations may have the following attributes:

| Field | Description |
|---|---|
| Name | Human readable location description, eg “front bar” |
| Timezone | Number of hours/minutes the location is ahead of behind |
| | GMT |
| Serving | Start and stop time for each day of the week that pouring of |
| hours | liquor is permitted at this location. If the stop time is earlier |
| | than the start time, then the serving period is assumed to |
| | cross midnight into the next day. |
| Daylight | Information relating to when (if at all) daylight savings comes |
| savings | into effect for the location, and how many minutes to put the |
| | clock forward when DST is in effect. This field and the |
| | timezone field both default to the correct data for the |
| | timezone specified in the Windows setup on the PC that SM |
| | is running on. |

The base stations screen allows the adding, removal and editing of base stations 15 in the system. Base station 15 attributes broadly relate to the base station's network settings and hardware configuration, examples of these are as follows:

| Field | Description |
|---|---|
| Location | Physical location of the base station chosen |
| | from locations configured in the location |
| | screen. |
| Name | Human readable name of the base station. |
| Enable DHCP | Use DHCP to get a dynamic IP address on start |
| | up. |
| IP address | IP address (if no DHCP) |
| Netmask | IP netmask (is no DHCP) |
| IP gateway | IP gateway (if no DHCP) |
| Enable radio | Enable the UHF wideband transceiver for pourer |
| | 14 communication. The only occasion where the |
| | radio would not be enabled is if the base |
| | station 15 was being used solely as a host for |
| | one or more RFID tag readers. |
| Serial port 1 | Baud rate and description for serial port 1. |
| | If set to TAGR, this enables a special DC |
| | power output mode on an unused serial pin that |
| | powers the RFID tag reader. |
| Serial port 2 | Baud rate and description for serial port 2. |
| | If set to TAGR, this enables a special DC |
| | power output mode on an unused serial pin that |
| | powers the RFID tag reader. |
| WLAN network | Ad-hoc or infrastructure mode (or none at all |
| type | if connectivity is via the Ethernet port). |
| WEP mode | 64 or 128 bit WEP key |
| WLAN channel | WLAN channel to use |
| WLAN SSID | WLAN SSID setting |
| WLAN WEP key | WLAN WEP key (can be entered either in ASCII |
| | or HEX mode) |
| WLAN scale | Low, Medium or High |
| Enable debug | If enabled this causes the base station 15 |
| | to output debug logging entries to serial |
| | port 1 during operation. This is used as a |
| | diagnostic troubleshooting tool at a customer |
| | site. |

The ‘scan network’ button on the base station screen causes a broadcast UDP packet to be sent out on the LAN which each directly connected base station 15 will respond to. This is a convenient way of configuring multiple base stations 15 in one go, as it will detect any base stations 15 either not in the database or with incorrect IP address settings. The poller 9 uses a similar scan network function before each base station 15 polling run to make sure it's IP address information is up to date. When running in dynamic host configuration protocol (DHCP) mode, it is possible for a base station 15 to obtain a different IP address without poller 9 or SM 8 being aware of the change, so this functionality is necessary to refresh the IP address information. Generally this only works for the directly connected LAN as most routers do not by default propagate UDP broadcasts. For this reason the DHCP option is only recommended for use on base stations 15 that are on the same LAN as the poller 9.

The export screen is where the admin can configure regular exports of user, inventory and activity data. The export format is a standard comma delimited ASCII file. Various date and volume formats can be selected for maximum compatibility with third party software, along with options for full or incremental data sets. The poller 9 automatically runs exports at the configured intervals, or immediately when the ‘force run now’ button is clicked in the SM 8.

The import screen permits the configuration of multiple data imports. A data import can be user, inventory or point of sale (POS). A user import might come from a payroll system, inventory from the inventory system and point of sale from a POS system. Multiple options allow configuration of date formats, volume units, delimiter characters, field order and actions to take prior to and after an import.

In a further preferred arrangement one import option relates to duplicate entries. Where an item already exists in the database, the new item can either overwrite the existing one, be discarded or partially imported, ie only specific fields will be overwritten. Various options also exist for extracting import data from subfields within comma delimited fields.

The spouts screen is a diagnostic tool that shows the status of every pourer 14 at a glance. Each pourer 14 is listed, along with vital statistics such as battery level, temperature, the beverage container 12 product it is associated with (if any), physical location, and the time and date of the last activity and heartbeat updates. Also tracked is the valve usage counter. This is a variable that is factory programmed to zero at manufacture time, and increments every time the flexible pinch valve tube is compressed. It's not known at this time what the expected life of the tube will be, but eventually this counter will be needed to track pourers 14 that have valves approaching their end of life.

In a further embodiment, the server can also manage the stock control of the enterprise and charging of customers. By identifying a container 12 by the scanner 18, the software of the server 16 can be configured to automatically identify the charge per serve to be made. Further, a RFID sensor can also be integrated with the cash registers of the enterprise. When the barman 10 operates a cash register, he is identified at the cash register and the last drink poured and the outstanding fee is displayed. He need only enter the amount which has been tendered by the customer and the change will be identified. As a result, the time at the cash register and the risk of error will be reduced.

In another embodiment, as shown in FIGS. 20a and 20b, a more sophisticated scanner 91 is provided. This scanner 91 includes an elongate body having a scanning means 92 centrally located along its length in a central portion 93. At a first end 94, a single magnet 95 is provided while at the opposed second end 96 two magnets 97 and 98 are provided, disposed at differing positions from the second end. The first end 94 and the second end 96 are of sufficiently small diameter to enable a respective end to be inserted a short way into the mouth of the upper end of the housing portion 41 of the pourer body 31. The central portion 93 is of enlarged diameter to prevent the scanner 90 from being inserted excessively. The beverage dispensing controller 23 of this embodiment incorporates a pair of magnetic reed switches (not shown) disposed proximate the mouth of the body 41 of the pourer, the second switch being disposed more inwardly with the pourer 14, than the first. In use, when the first end 94 of the scanner 90 is inserted into the pourer, the first magnetic reed switch is caused to close by the magnet 95 at the first end 94. This is interpreted as an unlock instruction by the beverage dispensing controller. The RFID tag reader scans for the identity of the barman to ensure that this action is authorised, and the beverage dispensing controller 23 thereafter unlocks the locking means When the second end 96 of the scanner 90 is inserted into the pourer, the second magnetic reed switch is caused to close by the magnet 98 while the first magnetic reed switch is held closed by magnet 97. This response is interpreted as a lock signal. The identity of the barman is determined and to complete the locking process, the scanner must then be used to scan the barcode of the container. Once the container is identified the beverage dispensing controller 23 completes the locking operation. In this way the system is reliably provided with the identity of the container at the time the pourer 14 is locked to it.

In another preferred arrangement as shown in FIGS. 21a and 22b and 22a, 22b and 22c the scanner 91 consists of an elongate body 93 and a cap 109. The body 93 houses a magnet 111 used to activate the reed switch of the pourer 14 to indicate that the scanner 91 is in close proximity. The cap 109 houses the scanner head 112 used to scan the barcode of the beverage container 12. The cap 109 also houses the battery 110 which powers the scanner 91 and lock/unlock switches 106 and 107. An indicator LED 108 is also housed in the cap 109 to indicate the charge level of the battery 110 and can also be used to give a visual indication of a successful scan of the container barcode.

As shown in FIG. 22b the scanner body 93 fits over the pourer cap 19 to lock/unlock the pourer 14 from a beverage container 12. As shown in FIG. 22c the scanner body 93 can also be used in conjunction with the battery charger 130 of FIGS. 24a and 24b to house the battery charger 130. The battery charger 130 is placed inside the body 93 and located within the charging locater holes 3 to change the battery 2b.

The scanner itself does not contain an RFID tag reader, therefore when held by a user wearing an RFID tag reader, for example a ring on a finger of the hand holding the scanner, the pourer will identify if the user is authorised to lock/unlock a pourer 14. When the lock switch is pressed on the scanner the scanner can then scan the bar code. Once the bar code has been scanned the scanner is then placed on top of the pourer 14. With the scanner on the pourer 14 the permanent magnet located within the scanner activates the reed switch in the pourer. The reed switch then activates an infrared sensor which sets up an infrared link between the pourer and scanner to enable the exchange of necessary data such as the bar code of the beverage container and the signal to lock. The pourer then activates an RFID reader which detects the identification of the user. Once the users identification is detected the pourer sends data to the base station which then checks and authorises or declines the request to lock the pourer.

In an alternative embodiment, the valve mechanism described above can be replaced with a valve able to sense the volume or flow rate of the beverage dispensed.

Use of the system provides many advantages:
Detailed activity tracking. Every single pour is recorded and logged, along with the brand of liquor, amount poured and the bartender who poured it.
Comparison of these data with Point of Sale (POS) reports quickly shows any discrepancies. The operator is able to precisely identify the drinks being poured and the barman who has served them.
Aesthetically neutral. The pourer spouts that affix to the liquor bottles are small and unobtrusive, being only slightly larger than a normal spout.

There are no wires or ungainly equipment on view.
Easy to install. The entire system is wireless, so there are no cables to retrofit or holes to drill.
The system does not interfere with normal bartending practices.

Bartenders can still free-pour, flip bottles etc as if the system were not even there. Changing pourers when a bottle is empty is almost as simple as removing a regular spout.
Secure. Once a pourer has been fixed to a bottle, it can only be physically removed by an authorised person. A locked pourer will only allow liquor to be poured by bartenders known to the system.
Flexible. The operator is able to decide who can pour what, and when. It's even possible to configure certain pouring rules for individual bottles and bartenders. For example, it's possible to allow an experienced bartender to free-pour, but when a junior bartender pours from the some bottle the liquor is automatically measured in preset portions.

Those skilled in the art will recognize that the embodiment may be varied in many ways while not departing from character of the invention. It is to be appreciated that all such adaptations are to be considered to fall within the scope of the present invention.

The claims defining the invention are as follows:

1. A pourer including:
a beverage dispensing controller including a valve to control the dispensing of a beverage by said pourer;
a cap including a locking system to releasably secure said cap to a beverage container, wherein said cap further includes a cap body having an outer duct extending from said cap body;
wherein said locking system further includes:
a collar with a central aperture for receiving said outer duct, said aperture allowing said collar to pass over said outer duct and at least one locking tab located on said cap body;
a slide which engages said collar;
a clamp engaging said at least one locking tab on said cap body, wherein said clamp is engaged by said slide to thereby secure said cap to said beverage container; and
a locking means which when engaged acts to prevent rotation of said collar.

2. A pourer according to claim 1, wherein said clamp includes a plurality of fingers about said pourers periphery extending generally parallel to a central axis from a rim, said fingers having radially inwardly directed teeth at their ends disposed from said rim and being deflected inwardly to drive said teeth into engagement with said container by deflection of said fingers due to engagement with said slide.

3. A pourer according to claim 1, wherein said pourer further includes at least one tilt switch to identify said beverage container orientation.

4. A pourer according to claim 1, wherein said locking means is unlocked only after identification of an authorised user.

5. A pourer according to claim 4, wherein the identity of said authorised user is verified locally or remotely

6. A pourer according to claim 1, wherein said valve is a latching pinch valve.

7. A pourer according to claim 1, wherein said pourer further includes a transceiver for communication of signals associated with the control of said beverage dispensing controller.

8. A pourer according to claim 1, wherein said locking means can be disengaged remotely or by an electric signal.

9. A pourer according to claim 1, wherein said pourer further includes a temperature sensor to determine the ambient temperature, wherein the ambient temperature sensed by said temperature sensor and the kinematic viscosity of said beverage is used to determine the amount of beverage to be dispensed from said beverage container.

10. A pourer according to claim 1, wherein said pourer further includes an air valve to allow one-way air flow in said pourer.

11. A pourer according to claim 10, wherein said air valve is an umbrella type air valve.

12. A pourer according to claim 1, wherein said pourer further includes a personnel identification means used to identify a user.

13. A pourer according to claim 12, wherein said personnel identification means includes an RFID tag.

14. A pourer according to claim 13, wherein said personnel identification means is located in a wristband to be applied to a wrist of a user, or a ring to be located on a finger of a user.

15. A pourer according to claim 1, wherein said pourer further includes an accelerometer to detect changes in acceleration of said beverage being dispensed.

16. A pourer including:
a beverage dispensing controller including a valve to control the dispensing of a beverage by said pourer;
a cap including a locking system to releasably secure said cap to a beverage container, wherein said cap further includes a cap body having an outer duct extending from said cap body;
wherein said locking system further includes:
a collar with a central aperture for receiving said outer duct, said aperture allowing said collar to pass over said outer duct and at least one protrusion located on said outer duct;
a slide which engages said collar;
a clamp engaging said at least one protrusion on said outer duct, wherein said clamp is engaged by said slide to thereby secure said cap to said beverage container; and
a locking means which when engaged acts to prevent rotation of said collar.

17. A beverage control system including:
at least one beverage container;
at least one pourer releasably secured to a respective outlet of each said beverage container,
wherein said pourer further includes:
a beverage dispensing controller including a valve to control the dispensing of a beverage by said pourer;
an actuator to control said valve, wherein said actuator is responsive to a control signal transmitted remotely from a base station when said base station is signalled that an authorised user is attempting to pour a beverage from said container, said control signal is transmitted by wireless transmission and received by a transceiver associated with said pourer.

18. A beverage control system according to claim 17, wherein the beverage dispensing controller controls the time or volume for which said beverage is dispensed.

19. A beverage control system according to claim 17, wherein a transceiver is associated with said pourer.

20. A beverage control system according to claim 17, wherein said beverage control system further includes a personnel identification means to identify a user.

21. A beverage control system according to claim 20, wherein said personnel identification means includes an RFID tag.

22. A beverage control system according to claim 21, wherein said personnel identification means is located in a wristband to be applied to a wrist of a user, or a ring to be located on a finger of a user.

23. A beverage control system according to claim 21, wherein said pourer further includes an identification scanner to detect the proximity of said personnel identification means.

24. A beverage control system according to claim 17, wherein said beverage control system further includes a container identification means to provide the identity of said beverage container to said system.

25. A beverage control system according to claim 24, wherein said container identification means includes a cordless barcode scanner to scan a standard barcode disposed on said beverage container.

26. A beverage control system according to claim 24, wherein said container identification means cooperates with the pourer, the container identification means being housed in a housing having at least one actuator means, whereby when a first actuator means is engaged an unlock signal is signalled to said pourer and when a second actuator means is engaged a lock signal is signalled to said pourer.

27. A beverage control system according to claim 26, wherein said lock signal must be completed by identification of said container by said container identification means.

28. A beverage control system according to claim 17, wherein said beverage dispensing controller includes at least one tilt switch to identify said beverage container orientation.

29. A beverage control system according to claim 17, wherein said beverage control system further includes a computer system to configure said beverage control system, wherein said computer system further includes a database to store information concerning the operation of said system and record information output by said beverage control system.

30. A beverage control system according to claim 29, wherein a base station reports information to said computer system and receives configuration information from said computer system.

31. A method of operating a beverage control system including:
dispensing a beverage from a releasably secured pourer by a beverage dispensing controller including a valve to control the dispensing of said beverage from said pourer;
controlling said valve by an actuator, wherein said actuator is responsive to a control signal transmitted remotely from a base station when said base station is signalled that an authorised user is attempting to pour a beverage from a beverage container, said control signal being transmitted by wireless transmission and received by a transceiver associated with said pourer.

32. A method of operating a beverage control system according to claim 31, further including at least one beverage container wherein at least one pourer releasably secured to a respective outlet of each said beverage container.

33. A method of operating a beverage control system according to claim 31, wherein said beverage dispensing controller controls the time or volume for which said beverage is dispensed.

34. A method of operating a beverage control system according to claim 31, wherein a transceiver is associated with said pourer.

35. A method of operating a beverage control system according to claim 31, wherein said beverage control system further includes a personnel identification means to identify a user.

36. A method of operating a beverage control system according to claim 35, wherein said personnel identification means includes an RFID tag.

37. A method of operating a beverage control system according to claim 36, wherein said personnel identification means is located in a wristband to be applied to a wrist of a user; or a ring to be located on a finger of a user.

38. A method of operating a beverage control system according to claim 35, wherein said pourer further includes an identification scanner to detect the proximity of said personnel identification means.

39. A method of operating a beverage control system according to claim 38, wherein said beverage control system further includes a container identification means to provide the identity of said beverage container to said system.

40. A method of operating a beverage control system according to claim 39, wherein said container identification means includes a cordless barcode scanner to scan a standard barcode disposed on said beverage container.

41. A method of operating a beverage control system according to claim 39, wherein said container identification means cooperates with said pourer, said container identification means being housed in a housing having a at least one actuator means, whereby when a first actuator means is engaged an unlock signal is signalled to said pourer and when a second actuator means is engaged a lock signal is signalled to said pourer.

42. A method of operating a beverage control system according to claim 41, wherein said lock signal must be completed by identification of said container by said container identification means.

43. A method of operating a beverage control system according to claim 31, wherein said beverage dispensing controller includes at least one tilt switch to identify said beverage container orientation.

44. A method of operating a beverage control system according to claim 31, wherein said beverage control system further includes a computer system to configure said beverage control system, wherein said computer system further includes a database to store information concerning the operation of said beverage control system and record information output by said beverage control system.

45. A method of operating a beverage control system according to claim 31, wherein said beverage control system includes at least one base station to receive information from at least one pourer and to transmit signals to said at least one pourer.

46. A method of operating a beverage control system according to claim 31, wherein said base station reports information to said computer system and receives configuration information from said computer system.
